(19) United States
(12) Patent Application Publication
(10) Pub. No.: US 2015/0351411 A1
(43) Pub. Date: Dec. 10, 2015

(54) Baking plate for wafer or waffle baking machines, baking apparatus and method for manufacturing baking plates

(71) Applicant: HAAS FOOD EQUIPMENT GMBH, Wien (AT)

(72) Inventors: Reinhart ADAM, Wien (AT); Johannes HAAS, Wien (AT); Josef HAAS, Leobendorf (AT); Stefan JIRASCHEK, Koenigsbrunn (AT)

(21) Appl. No.: 14/732,929

(22) Filed: Jun. 8, 2015

Related U.S. Application Data
(60) Provisional application No. 62/008,771, filed on Jun. 6, 2014.

(51) Int. Cl. A21B 5/02; C23C 8/32; C23C 8/02; C23C 8/10; C22C 37/00; C21D 6/00; C21D 8/00; C21D 9/46; C22C 38/00; C23C 8/26; C21D 1/26

(52) U.S. Cl. CPC A21B 5/02; C23C 8/26; C23C 8/32; C23C 8/02; C23C 8/10; C21D 1/26; C21D 6/00; C21D 8/005; C21D 9/46; C22C 38/00; C22C 37/00

(57) ABSTRACT

A baking plate for wafer or waffle baking machines has at least one wafer or waffle baking surface formed in steel or cast iron by engraving and an optionally executed final processing. The at least one wafer or waffle baking surface is hardened by nitriding or nitrocarburizing, optionally with subsequent oxidizing. A baking apparatus and a method for manufacturing baking plates are also provided.

### CROSS-REFERENCE TO RELATED APPLICATION

This application claims the priority, under 35 U.S.C. §119(e), of Provisional Application No. 62/008,771, filed Jun. 6, 2014; the prior application is herewith incorporated by reference in its entirety.

### BACKGROUND OF THE INVENTION

### Field of the Invention

The invention relates to baking plates for wafer or waffle baking machines having wafer or waffle baking surfaces which are formed in steel or cast iron by engraving, and an optionally executed final processing. The invention also relates to a baking apparatus and a method for manufacturing baking plates.

Baking machines of that type are used to produce either soft waffles or brittle wafer sheets for the food industry. The baking plates are usually part of a baking plate tong which is movable for the baking of soft waffles or brittle wafer sheets by using a conveying device from a batter or dough feeding station through a baking chamber heated to a baking temperature as far as a removal station for the baking product. Wafer or waffle baking machines of that type have been prior art for decades.

After removing the baking product, the baking surfaces of the baking plates must be ready to receive dough or batter again in the dough or batter feeding station.

A problem arises when dough or batter or its residues remain suspended on the baking surface with the result that it is either necessary to clean the baking surface or the following baking product will be damaged.

The problem therefore arises of equipping the baking surfaces of the baking plates so that adhesion of dough or batter or baking residue is avoided. Furthermore, it should also be possible for subsequent but necessary cleaning processes to be carried out as simply as possible without damaging the wafer or waffle baking surfaces.

### SUMMARY OF THE INVENTION

It is accordingly an object of the invention to provide a baking plate for wafer or waffle baking machines, a baking apparatus and a method for manufacturing baking plates, which overcome the hereinafore-mentioned disadvantages of the heretofore-known plates, apparatuses and methods of this general type and in which wafer or waffle baking surfaces are hardened by nitriding or nitrocarburizing, optionally with subsequent oxidizing.

With the foregoing and other objects in view there is provided, in accordance with the invention, a baking plate for wafer or waffle baking machines. The baking plate comprises at least one wafer or waffle baking surface formed in steel or cast iron by engraving and an optionally executed final processing. The at least one wafer or waffle baking surface is hardened by nitriding or nitrocarburizing, optionally with subsequent oxidizing.

It was heretofore known to coat wafer or waffle baking surfaces with a material which reduces adhesiveness. For example, it is known to coat the wafer or waffle baking surfaces with Teflon®. However, the coating has the disadvantage that it is subject to wear in the course of use and after a relatively short time peels off from the wafer or waffle baking surface and therefore the baking plate becomes unusable.

The baking plates according to the invention which are also configured by the method according to the invention avoid all of these disadvantages. As a result of the hardening by nitriding or nitrocarburizing, a hardened and very smooth metal surface is produced on which the dough or batter or baking residues do not adhere. If contamination should nevertheless occur, it can easily be removed, for example, by brushing off in a brushing station. The brushing of surfaces is a known and inexpensive process which is substantially easier to handle from the mechanical engineering point of view than, for example, the known wet washing with detergents and subsequent drying.

The baking plate material is formed either of steel or cast iron. All known types of cast iron can be used. They have a carbon content of about 2-5% and a silicon content of about 1-3%. Any alloying components can be added and are well-known in iron technology.

The steels are alloyed steels having appreciable quantities of alloying components which are different from carbon and usually contain accepted quantities of manganese, silicon, sulfur and phosphorus. These alloys serve to advantageously influence the mechanical and physical properties. Low-alloyed steels are usually those having less than 5% alloying elements and those having more than 5% alloying elements are called high-alloyed steels. Stainless steels are usually iron alloys having a chromium fraction of at least 10.05%. Pure carbon steels are usually those formed predominantly of iron and carbon, where the maximum content of carbon is 2% and only small traces of other elements are present apart from those additives which are added for deoxidation, where the silicon content is usually limited to 0.6% and the manganese content is limited to 1.65%.

Generally speaking, all steels and irons can be used which are formed for the most part of non-amorphous material having a largely metallic binding character and a mass fraction of more than 50% iron.

The hardening processes have already been known in practice for a fairly long time, e.g. from the hardening of gear wheels. This includes nitriding, nitrocarburizing and nitrocarburizing with subsequent oxidizing. Due to these treatment processes an at least largely closed layer having a high ceramic character is formed on the surface of the metal. This layer forms the ceramic character in the near-surface volume as a result of increased mass fractions of nitrogen and possibly carbon compounds of the metal components of the material and nitrogen and/or carbon.

In order to carry out the nitrocarburizing, the prepared baking plates having wafer or waffle baking surfaces which are provided with the desired engraving and have optionally been finished, such as, for example, polished, are dispatched through nitrocarburizing furnaces. In order to carry out the nitrocarburizing, carbon donors such as, for example, carbon dioxide or so-called exogas or endogas are supplied temporally consecutively to the furnace atmosphere. The known gases are left to act on the surfaces for a fairly long time at elevated temperature. Times of action lie between 0.5 and 10 hours and the temperatures vary between 400° C. and 800 ° C.

Furthermore, the nitriding processes can also be carried out by plasma nitriding, in which nitrogen is provided as a nitrogen donor. In this case, the workpieces are connected to a cathode and the furnace-side retort wall is connected to an anode. The furnace chamber is evacuated to less than 10 mbar and a voltage of several hundred volts is applied between the anode and the cathode. A glow discharge is produced in the immediate vicinity of the workpiece surface with a constant or pulsating DC current having a current intensity of about 10 amperes.

During the nitrocarburizing, an oxidizing process can also be carried out after this process. The hardening takes place in the metal material of the wafer baking surface preferably up to a depth of more than 0.05 mm, preferably at a depth of 0.2-0.3 mm.

With the objects of the invention in view, there is also provided a baking apparatus, comprising a baking chamber which can be heated to a baking temperature, and a conveying device for transporting baking plates according to the invention from a dough or batter feeding station through the baking chamber to a removal station for the baked product.

With the objects of the invention in view, there is concomitantly provided a method for manufacturing baking plates, which comprises the following process steps:

a) manufacturing the baking plate from cast iron or steel;

b) low-stress annealing of the baking plate;

c) engraving the wafer or waffle baking surface(s) of the baking plate;

d) optionally final processing such as polishing the wafer or waffle baking surfaces; and

e) coating-free hardening of the wafer or waffle baking surfaces.

Other features which are considered as characteristic for the invention are set forth in the appended claims.

Although the invention is illustrated and described herein as embodied in a baking plate for wafer or waffle baking machines, a baking apparatus and a method for manufacturing baking plates, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of an example of a baking plate having a baking surface according to the invention; and

FIG. 2 is a side-elevational view of a baking apparatus.

### DETAILED DESCRIPTION OF THE INVENTION

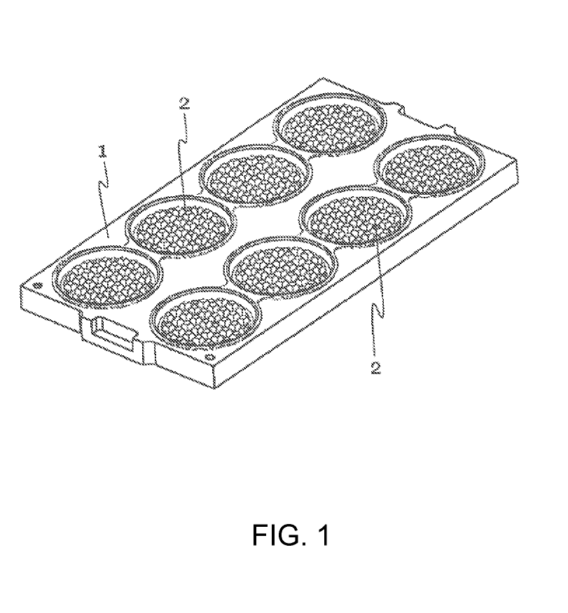

Referring now in detail to the figure of the drawing and first, particularly to FIG. 1 thereof, there is seen a baking plate 1 which, for example, is a lower part of a baking plate tong, having a total of eight waffle baking surfaces 2 on its upper surface.

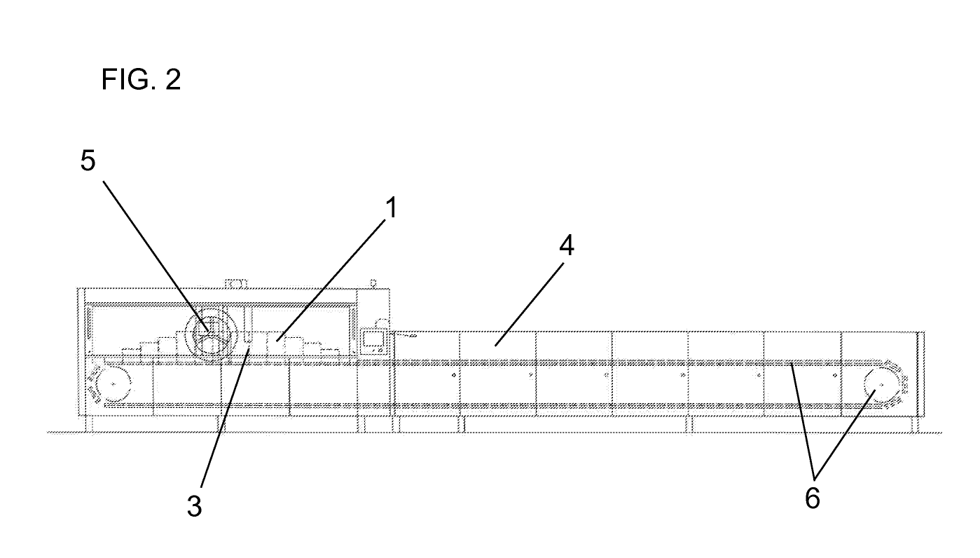

FIG. 2 shows a baking apparatus having a dough or batter feeding station 3, a baking chamber 4, a removal station 5 and a conveying device 6 for the baking plates 1 shown in FIG. 1. A liquid batter is poured onto the open waffle baking surfaces 2 of the baking plates 1 in the batter feeding station 3 for baking soft waffles. After closing the baking tongs and passing through the baking chamber 4, the baked soft waffles are removed and the baking plate tong is fed to the batter feeding station 3 again.

1. A baking plate for wafer or waffle baking machines, the baking plate comprising:
at least one engraved steel or cast iron wafer or waffle baking surface being hardened by nitriding or nitrocarburizing.

2. The baking plate according to claim 1, wherein said at least one wafer or waffle baking surface has been subjected to final processing.

3. The baking plate according to claim 1, wherein said at least one wafer or waffle baking surface has been oxidizing subsequent to said nitriding or nitrocarburizing.

4. The baking plate according to claim 1, wherein the baking plate is part of a baking plate tong configured for baking soft waffles or brittle wafer sheets.

5. The baking plate according to claim 1, wherein said at least one wafer or waffle baking surface is hardening to a depth of more than 0.05 mm.

6. The baking plate according to claim 1, wherein said at least one wafer or waffle baking surface is hardening to a depth of 0.2 to 0.3 mm.

7. The baking plate according to claim 1, wherein the baking plate is formed of steel or cast iron or is fabricated using steel or cast iron, and said at least one wafer or waffle baking surface is formed of a metal being nitridable or nitrocarburizable.

8. A baking apparatus, comprising:
a dough or batter feeding station;
a baking chamber configured to be heated to a baking temperature;
a removal station for a baked product; and
a conveying device for transporting baking plates according to claim 1 from said dough or batter feeding station through said baking chamber to said removal station.

9. A method for manufacturing baking plates for wafer or waffle baking machines, the method comprising the following steps:
a) manufacturing a baking plate from cast iron or steel;
b) low-stress annealing of the baking plate;
c) engraving at least one wafer or waffle baking surface of the baking plate;
d) carrying out optional final processing of the at least one wafer or waffle baking surface; and
e) coating-free hardening of the at least one wafer or waffle baking surface.

10. The method according to claim 9, which further comprises carrying out the final processing by polishing.

11. The method according to claim 9, which further comprises carrying out the hardening by nitriding or nitrocarburizing at low temperatures.

12. The method according to claim 9, which further comprises oxidizing subsequently to the nitriding or nitrocarburizing at low temperatures.

13. The method according to claim 9, which further comprises carrying out the hardening by nitrocarburizing and subsequent oxidizing in a protective gas atmosphere at temperatures between 400° C. and 800° C. and a duration of action of 0.5 to 10 hours to achieve a hardening depth of at least 0.05 mm.

14. The method according to claim 13, wherein the duration of action is between 2 and 3 hours.

15. The method according to claim 13, wherein the hardening depth is 0.2 to 0.3 mm.
